(19) United States
(12) Patent Application Publication
(10) Pub. No.: US 2007/0174243 A1
(43) Pub. Date: Jul. 26, 2007

(54) Mobile social search using physical identifiers

(76) Inventor: Charles W. Fritz, Fort Myers, FL (US)

Correspondence Address: ANTHONY R. BARKUME, 20 GATEWAY LANE, MANORVILLE, NY, 11949, US

(21) Appl. No.: 11/336,422

(22) Filed: Jan. 20, 2006

(51) Int. Cl. G06F 17/30

(52) U.S. Cl. 707/3

(57) ABSTRACT

The present invention is a method and system for executing a mobile social search. A primary user will operate a portable device such as a cell phone, PDA or the like for machine-reading a physical token associated with a fixed physical location at which the primary user is in proximity in order to obtain a physical token identifier. For example, the primary user may use a camera-enabled cell phone in order to capture an image of a bar code printed on an object in his proximity. A query is then transmitted from the portable device to a central server computer. The query will have several pieces of information, such as a primary user identifier, the physical token identifier (e.g. the scanned bar code data), and primary user location data indicative of the location of the primary user at that time. The query is processed by the central server computer to obtain secondary user identification of at least one secondary user determined to be proximate to the primary user and having at least one predetermined parameter correlated to a predetermined parameter of the primary user. The central server computer then transmits the secondary user identification to the portable device.

### BACKGROUND OF THE INVENTION

This application relates to a central server computer than matches various users in the same location having similar social interests as may be determined by links to physical objects and indicia.

In this increasingly mobile society, people often want to find other people that may be located in their geographical area and having similar interests. In particular, in large metropolitan areas, people move about with great frequency and often feel disconnected from society. The present invention allows mobile users to find other mobile users having similar interests, and then communicate with those other users as desired.

### SUMMARY OF THE INVENTION

Thus, the present invention is a method and system for executing a mobile social search. The search is termed mobile since it encompasses users that may be proximate to each other at a given time, and thus the results will vary based on the relative mobility of the users at any time. The search is termed social since it encompasses users with similar interests to each other as determined by user profile information (for example obtained during a registration process) and/or current interest information based on inputting or scanning a physical identifier at the user's location (such as a bar code on a movie poster at a movie theater where the user is currently located).

Thus, a primary user will operate a portable device such as a cell phone, PDA or the like for machine-reading a physical token associated with a fixed physical location at which the primary user is in proximity in order to obtain a physical token identifier. For example, the primary user may use a camera-enabled cell phone in order to capture an image of a bar code printed on an object in his proximity. A query is then transmitted from the portable device to a central server computer. The query will have several pieces of information, such as a primary user identifier, the physical token identifier (e.g. the scanned bar code data), and primary user location data indicative of the location of the primary user at that time. The query is processed by the central server computer to obtain secondary user identification of at least one secondary user determined to be proximate to the primary user and having at least one predetermined parameter correlated to a predetermined parameter of the primary user. The central server computer then transmits the secondary user identification to the portable device.

For example, the secondary user identification may be a mobile telephone number of the associated secondary user, and then the primary user places a mobile telephone call to the associated secondary user with the portable device. Instead, the primary user may send a text or picture message to the associated secondary user with the portable device. Similarly, the secondary user identification may be an email address, and then the primary user sends an email to the associated secondary user with the portable device.

The primary user location data indicative of the location of the primary user may be obtained, for example, from a GPS unit associated with the portable device or via a mobile phone triangulation methodology. In addition, a user may enter location data manually as a supplement or override to the automatically derived location data (such as by entering “Midtown Manhattan” or “Broadway/42^{nd} St/NYC” or the like).

The central server computer processes the query from the primary user as follows. The location of the primary user is determined from the primary user location data. A user location database is then accessed to retrieve a list of secondary users that were previously registered at the central server computer as being located at a secondary user location. The central server computer then determines which of the secondary users are proximate to the location of the primary user. A user profile database is then accessed to retrieve user profile data for each of the proximate secondary users. A physical identifier database is accessed with the physical identifier data to retrieve physical identifier profile data. The central server computer then analyzes the user profile data for each of the proximate secondary users with respect to the physical identifier profile data to determine which of the proximate secondary users have at least one predetermined parameter correlated to the physical identifier input by the user.

In another embodiment, in addition to or instead of using the physical identifier scanned by the primary user, the user profile database is accessed to also retrieve user profile data for the primary user. The central server computer then analyzes the user profile data for each of the proximate secondary users with respect to the user profile data for the primary user to determine which of the proximate secondary users have at least one predetermined parameter correlated to a predetermined parameter of the primary user.

In another aspect of the invention, each secondary user may register as being located at a secondary user location by executing a login process with the user location database. In login process, the secondary user accesses the central server computer with a secondary user portable device, then the secondary user portable device transmits to the central server computer secondary user location data indicative of the location of the secondary user, and the central server computer stores the secondary user identification and the secondary user location data in the user location database.

In addition to informing the primary user of the existence of the proximate secondary user(s) that match the given profile and/or scanned bar code indicia, the present invention provides for a subsequent alert feature. That is, a secondary user may subsequently log in to the central server computer, and then the central server computer transmits an alert signal to the portable device of the primary user. The alert signal indicates the subsequent login of the secondary user proximate to the primary user.

### BRIEF DESCRIPTION OF THE DRAWING

FIG. 1 is a basic block diagram of the present invention.

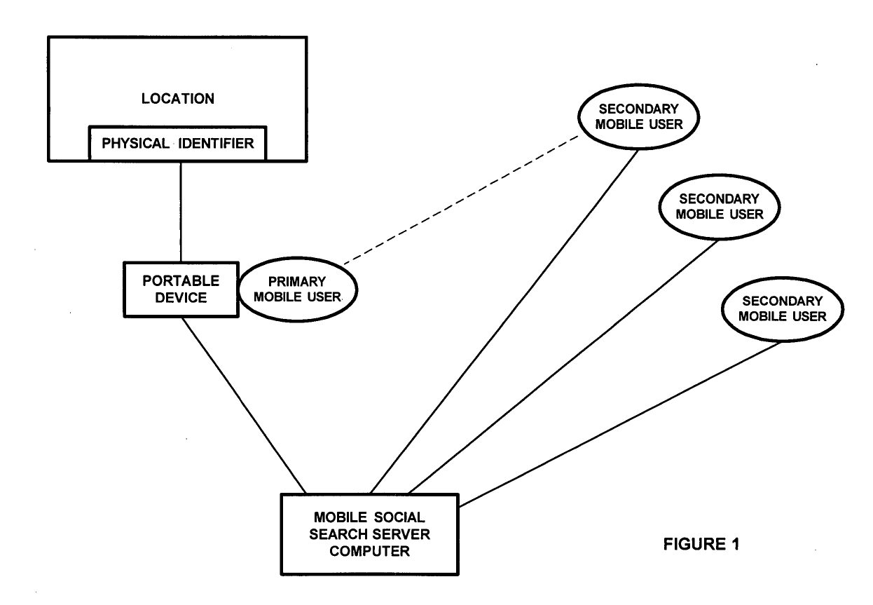

FIG. 2 is a more detailed diagram of the present invention.

### DETAILED DESCRIPTION OF THE PREFERRED EMBODIMENT

An example of the preferred embodiment will now be provided. As shown in the Figures, a primary mobile user having a portable mobile device such as a camera-enabled cell phone will be in an area known as location A. The location may be determined, for example, by any manner such as a global positioning satellite (GPS) methodology or triangulation methodology, both of which are well known in the art and need not be described in detail herein. In any event, the primary user may come upon something of interest, and for which he would like to find other mobile users having the same interest and located in the same location. Location of course may be defined by system parameters and may be specified by the primary user; for example, the same location may be the same block, the same town, within a certain radius from the user, etc.

As the primary user finds the physical item of interest, it is envisioned that this item will have a machine-readable physical indicia associated with it. For example, the item of interest may be a movie poster of a currently-playing movie, and a bar code symbol encoded with data indicative of the movie may be printed on the poster. Similarly, the item of interest may be a music CD with a UPC bar code on the package that uniquely identifies the CD in accordance with the UPC standard. Also, the item of interest may be an advertisement in newspaper or magazine regarding an upcoming sporting event such as the Super Bowl.

The user, having decided he would like to communicate with another user at his location with a similar interest, will scan the bar code on the item, for example by capturing an image of the bar code on his camera-enabled cell phone. The bar code will be imaged and a query will be prepared by software resident on the portable device. The query will include three basic pieces of information: an identification of the primary user (which may for example be a user ID, name or the like), a physical token identifier (such as the bar code image or decoded data), and primary user location data that indicates the current location of the portable device (such as GPS coordinates). That is, the query indicates who is making the query, where the user is, and what the current interest of the user is.

The query is received by a central server computer also referred to as a mobile social search server computer. The central server operates on the query and processes it to prepare a response transmission to be sent back to the primary user's portable device. The processing may involve different combinations of the following steps as further described herein.

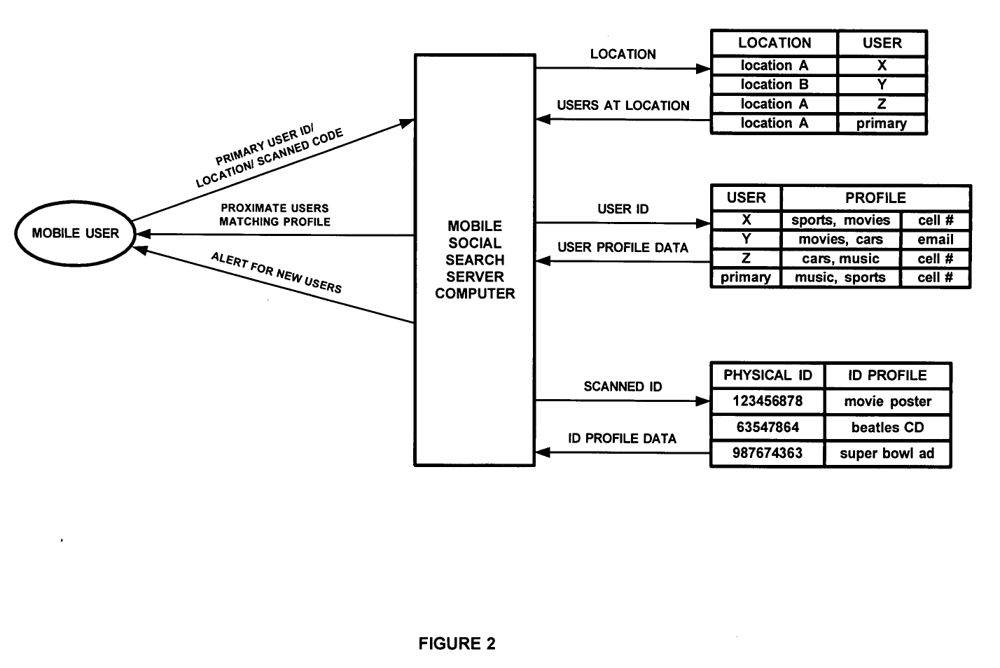

First, the central server will use the primary user location data to access a user location database. The user location database will list all of the registered users of the system and their current location, assuming they are logged into the system. For example, as shown in FIG. 2, the user location database stores records that indicate that user X is at location A, user Y is at location B, user Z is at location A, and the primary user record is updated to indicate that he is currently at location A. Since the primary user has made the query to the system, all other users who are indicated to be at location A are retrieved from the user location database (i.e. users X and Z). These users are considered to be proximate users.

The central server then accesses a user profile database to obtain user profile information for each of the proximate users (also referred to as proximate secondary users since they are proximate to the primary user). The user profile information has been previously obtained during a user registration process, to be described further herein. The user profile data will include an indication of various interests of that user, such as sports, movies, cars, music, etc. As shown in FIG. 2, user X is interested in sports and movies, user Y is interested in movies and cars, user Z is interested in cars and music, and the primary user is interested in music and sports.

The central server then may use the scanned physical identifier information of the query to determine the current interest of the primary user as indicated by the physical item just scanned by the primary user. In this example, the primary user has scanned a bar code on a Star Wars movie poster at the theater where he is considering attending that movie. The bar code data “12345678” is used to look up the physical ID profile information, which indicates the physical item was a movie poster.

The central server then uses these pieces of information to perform a matching analysis. The central server will look for proximate users (X and Z in the example) that have an interest in movies, since that is the item that the primary user has just scanned. In this case, only user X is interested in movies. Thus, the central server will prepare the response transmission to include an identification of user X, which may include contact information as retrieved from the user profile database. Thus, the cell phone number of the proximate user X will be sent to the portable device of the primary user, optionally with a message such as “Call or text message the user at 212-555-1234, who is in your location and likes movies”. The primary user may then make contact with user X accordingly, and the users may decide to meet to attend the movie, discuss the movie, etc.

The user profile database may also include profile information of the primary user that may supplement the analysis by the central server. For example, the central server may use only the prestored profile data (and not the scanned bar code) to match similarly-interested users). This may occur perhaps if no physical indicia is provided with the query, or if there is no profile information stored for that bar code, etc. In the primary user will be provided with information regarding proximate users that have the same interests as determined by the user profile database, without referring to the scanned physical indicia.

In another embodiment, interest matching by the central server computer may occur as a result of bar codes or other indicia scanned by the proximate users as well as the primary user, in addition to or instead of having preprogrammed interest profile data. In this case, only those proximate users that have recently scanned the Star Wars movie poster (thus indicating a current interest in the Star Wars movie at that location) will be flagged to the primary user after he scans the movie poster at that location.

A user may login by simply placing a call to a central telephone number, by sending a text message or email, etc. Similarly, a user may logout in the same manner. In the alternative to logging out, a user may login and specify a time duration after which he will be automatically logged out.

The registration procedure allows users to enter their contact information (email, cell number, etc.) as well as a user profile that indicates their interests such as movies, poetry, sports, technology, etc. This information is store din the databases shown in FIG. 2 and referred to for matching criteria as previously explained.

I claim:

1. A method for executing a mobile social search comprising the steps of
a. a primary user operating a portable device for machine-reading a physical token associated with a fixed physical location at which the primary user is in proximity in order to obtain a physical token identifier;
b. transmitting a query from the portable device to a central server computer, said query comprising
i. a primary user identifier,
ii. the physical token identifier, and
iii. primary user location data indicative of the location of the primary user;
c. processing the query by the central server computer to obtain secondary user identification of at least one secondary user determined to be proximate to the location of the primary user and having at least one predetermined parameter correlated to a predetermined parameter of the primary user; and
d. the central server computer transmitting the secondary user identification to the portable device.

2. The method of claim 1 further wherein the secondary user identification comprises a mobile telephone number of the associated secondary user, and wherein the primary user places a mobile telephone call to the associated secondary user with the portable device.

3. The method of claim 1 further wherein the secondary user identification comprises a mobile telephone number of the associated secondary user, and wherein the primary user sends a text message to the associated secondary user with the portable device.

4. The method of claim 1 further wherein the secondary user identification comprises a mobile telephone number of the associated secondary user, and wherein the primary user sends a picture message to the associated secondary user with the portable device.

5. The method of claim 1 further wherein the secondary user identification comprises an email address of the associated secondary user, and wherein the primary user sends an email to the associated secondary user with the portable device.

6. The method of claim 1 wherein the primary user location data indicative of the location of the primary user is obtained from a GPS unit associated with the portable device.

7. The method of claim 1 wherein the primary user location data indicative of the location of the primary user is obtained via a mobile phone triangulation methodology.

8. The method of claim 1 wherein the processing step comprises the steps of:
i. determining the location of the primary user from the primary user location data;
ii. accessing a user location database to retrieve a list of secondary users, each of said secondary users previously registered at the central server computer as being located at a secondary user location;
iii. determining which of said secondary users are proximate secondary users by ascertaining which of said secondary users are proximate to the location of the primary user.

9. The method of claim 8 wherein each secondary user registers as being located at a secondary user location by executing a login process with the user location database.

10. The method of claim 9 wherein the login process comprises the steps of:
i. the secondary user accessing the central server computer with a secondary user portable device,
ii. the secondary user portable device transmitting to the central server computer secondary user location data indicative of the location of the secondary user, and
iii. the central server computer storing the secondary user identification and the secondary user location data in the user location database.

11. The method of claim 10 further comprising the steps of:
a. a secondary user subsequently logging in to the central server computer; and
b. the central server computer transmitting an alert signal to the portable device of the primary user, said alert signal indicating the subsequent login of the secondary user proximate to the primary user.

12. The method of claim 8 further comprising the steps of:
i. accessing a user profile database to retrieve user profile data for each of said proximate secondary users,
ii. accessing a physical identifier database with the physical identifier data to retrieve physical identifier profile data, and
iii. analyzing the user profile data for each of said proximate secondary users with respect to the physical identifier profile data to determine which of said proximate secondary users have at least one predetermined parameter correlated to the physical identifier input by the user.

13. The method of claim 8 further comprising the steps of:
i. accessing a user profile database to retrieve user profile data for each of said proximate secondary users,
ii. accessing the user profile database to retrieve user profile data for said primary user, and
iii. analyzing the user profile data for each of said proximate secondary users with respect to the user profile data for said primary user to determine which of said proximate secondary users have at least one predetermined parameter correlated to a predetermined parameter of the primary user.

14. The method of claim 1 wherein the step of a primary user operating a portable device for machine-reading a physical token comprises the user scanning a bar code symbol.

15. The method of claim 14 wherein the portable device is a mobile telephone.

16. The method of claim 15 wherein the mobile telephone comprises a camera, and wherein the camera is operated by the primary user to capture the image of the bar code symbol.
